(19) United States
(12) Patent Application Publication
(10) Pub. No.: US 2012/0148477 A1
(43) Pub. Date: Jun. 14, 2012

(54) AQUEOUS SOLUTIONS OF CHLORINE DIOXIDE WITH ENHANCED STABILITY AND METHODS FOR PRODUCING AND PACKAGING THEM

(76) Inventors: Aaron A. Rosenblatt, New York, NY (US); Gilbert Gordon, Oxford, OH (US)

(21) Appl. No.: 13/378,103

(22) PCT Filed: Jun. 22, 2010
(86) PCT No.: PCT/US2010/039508

§ 371 Date: Feb. 29, 2012

Related U.S. Application Data
(60) Provisional application No. 61/219,598, filed on Jun. 23, 2009.

(51) Int. Cl. C01B 11/02

(52) U.S. Cl. 423/477

(57) ABSTRACT

Aqueous solutions of chlorine dioxide are disclosed. The solutions are substantially free of transition metal ions, transition metal oxides, particulate contaminants. The solutions are uniquely stable with respect to their chlorine dioxide concentration. The solutions can contain chlorine dioxide in the concentration range of about 100 ppm or more to about 10,000 ppm, more preferably about 1,000 ppm or more to about 5,000 ppm and even more preferably about 2,000 ppm or more to about 4,000 ppm, and most preferably about 3,000 ppm. Preferably the solutions are substantially free of organic carbon and metal ions. Methods are disclosed for preparing aqueous solutions of chlorine dioxide comprising (1) purifying water by at least two methods selected from the group consisting of deionization, distillation, reverse osmosis (RO) filtration, carbon filtration, microporous filtration, ultrafiltration, hyperfiltration, ultraviolet oxidation, and electrodialysis, and (2) dissolving filtered chlorine dioxide gas into the water.

### TECHNICAL FIELD

This disclosure relates generally to chlorine dioxide compositions having enhanced stability and to methods for producing and packaging them. The compositions are aqueous solutions of chlorine dioxide that are essentially free of multiple types of contaminants that reduce the concentration of chlorine dioxide in aqueous solutions through degradation.

### BACKGROUND

Chlorine dioxide, discovered in the early Nineteenth Century, is an oxidizing biocide used for a wide range of purposes including, without limitation, bleaching of paper pulp, treatment of drinking water, disinfection of premise plumbing and gas-phase sterilization of medical devices.

Chlorine dioxide is generally not manufactured at a central location and shipped to points of use, owing to its well-known instability. In the gas phase, chlorine dioxide reportedly can undergo explosive decomposition at concentrations above about 10% in air at Standard Temperature and Pressure (STP).

A variety of methods for generating chlorine dioxide are known. Most methods involve “wet chemistry”, in which aqueous solutions of sodium chlorite or sodium chlorate are reacted with other chemicals (e.g., hydrochloric acid), or electrolyzed in order to produce aqueous solutions of chlorine dioxide. Chapter 11 of George Clifford White's Handbook of Chlorination and Alternative Disinfectants, 4th Edition (Wiley, 1999) describes a number of such methods. Chapter 4 of the USEPA Office of Drinking Water's Alternative Disinfectants and Oxidants Guidance Manual (EPA No. 815-R-99-014; 1999) also reviews a number of chlorine dioxide production methods, particularly those intended for water treatment applications. There are examples in the literature of persons generating chlorine dioxide in aqueous solution by wet-chemistry means, then removing the gas (e.g., by air stripping) and dissolving it into water. White describes such a procedure. Both White and USEPA also describe “Gas:Solid™” method (trademark of CDG Environmental, LLC) of producing substantially chlorine-free chlorine dioxide gas from reaction of dilute chlorine gas with solid (e.g., flake) sodium chlorite.

There are a number of conflicting reports relating to the chemical stability of aqueous solutions of chlorine dioxide, including without limitation those produced by dissolving chlorine dioxide gas into water. The purity of the water in which the chlorine dioxide is dissolved is undefined, or is described only in a very limited way.

There also is discussion in the scientific literature about the possible deleterious effects on the stability of aqueous solutions of chlorine dioxide which may be caused by certain specific chemical contaminants, including alkali and alkaline earth metal ion salts (e.g., sodium, calcium, magnesium), sodium chloride, and free chlorine (especially hypochlorous acid), which contaminants are reportedly present in relatively-high concentrations in chlorine dioxide solutions produced by wet-chemistry methods.

McWhorter, et al. and Lee each describe means by which aqueous solutions of chlorine dioxide can be produced, which are of relatively higher purity than solutions that result directly from the original wet-chemistry mixtures. In both references, the contaminants that are avoided are the alkali and alkaline earth metal ion salts (e.g., sodium, calcium, magnesium), sodium chloride, and free chlorine (especially hypochlorous acid) associated with wet-chemistry production techniques.

Increased temperature and exposure to light (especially ultraviolet light) also are widely reported to cause the concentration of chlorine dioxide in aqueous solutions to deteriorate.

It generally has been believed, and there are numerous published references to the effect, that the concentration of chlorine dioxide in aqueous solutions is inherently unstable. However, the reported rates of decline of chlorine dioxide concentration vary widely, and there is a great deal of uncertainty, conflict and confusion in the literature with respect to the parameters that influence the rate and extent of the reported instability. Those skilled in the art generally consider the centralized production, storage and transport of chlorine dioxide to be impractical.

A. Pitochelli states (in U.S. Pat. No. 7,229,647): “Even in aqueous solution chlorine dioxide is unstable . . . limiting its use as a liquid product . . . on-site generation has been the only means for utilizing chlorine dioxide, which must be used within a day or two at most, 80-90% of its strength typically lost within 24 hours”.

Chlorine Dioxide: Chemistry and Environmental Impact of Oxychlorine Compounds by W. S. Masschelein (1979), summarized available information with respect to storage methods for chlorine dioxide, and emphasized the problems encountered. Masschelein concludes that, because of the chemical instability, explosive character, and lack of a satisfactory storage method, it has generally been necessary for chlorine dioxide to be manufactured at its place of use.

Methods for on-site generation of chlorine dioxide typically are complicated, capital intensive or produce chlorine dioxide of poor quality. Especially for small-volume and intermittent use, it would be advantageous to have a relatively concentrated aqueous solution of chlorine dioxide, which would maintain its concentration for extended periods without chemical deterioration of the chlorine dioxide.

Certain products marketed as “stabilized chlorine dioxide,” are known in the art. However, these are aqueous solutions of chlorite ion and are not actually chlorine dioxide as described herein. These “stabilized” products do not contain any chlorine dioxide.

### SUMMARY

Aqueous solutions of chlorine dioxide of novel composition are disclosed. The solutions are substantially free of transition metal ions, transition metal oxides, and particulate contaminants. The solutions are uniquely stable with respect to the chlorine dioxide concentration. The solutions can contain chlorine dioxide at concentrations in the range of about 100 ppm or more to about 10,000 ppm, more preferably about 1,000 ppm or more to about 5,000 ppm, even more preferably about 2,000 ppm or more to about 4,000 ppm, and most preferably about 3,000 ppm. Preferably, the solutions are substantially free of organic carbon (TOC) and dissolved metal ions.

Methods for preparing chlorine dioxide solutions comprising (1) purifying water by at least two methods selected from the group consisting of deionization; distillation; reverse osmosis (RO); adsorption (e.g., carbon filtration); microporous filtration; ultra-filtration; ultraviolet oxidation; hyperfiltration; and electrodialysis; and (2) dissolving substantially pure, filtered chlorine dioxide gas into the water.

Additional features and advantages are described herein, and will be apparent from, the following Detailed Description.

### DETAILED DESCRIPTION

“Solution concentration” is term used in the chlorine dioxide and water treatment art which generally is measured in parts-per-million (ppm) of chlorine dioxide in water. In water at standard temperature and pressure (STP), weight-by-weight units such as ppm and milligrams-per-liter (mg/L) are used interchangeably. Thus, the concentration of an aqueous chlorine dioxide solution of 1000 ppm=1000 mg/L=1 gram/L=0.01000 weight %.

The weight-by-weight terms used in the chlorine dioxide and water treatment art also is applied to dissolved chemicals, including dissolved solids.

The term “gas-phase concentration” refers to the concentration of chlorine dioxide in the gas phase expressed in mole-per-mole (i.e., numbers of molecules) units; these are considerably different than the weight-percent units) e.g., ppm) used to describe the concentration of chlorine dioxide in aqueous solution. In the gas phase, parts-per-million are not equivalent to milligrams-per-liter.

As molecules increase in size their molecular weight increases; they generally become less soluble in water and exist as “suspended” solids (also called “particles” or “colloids”).

Particles are sometimes described in terms of “particle size”. Visible particles are roughly 25 microns and larger in size.

Particle size is a construct introduced for comparing dimensions of solid particles. In references to particles, different terms of art are used. Some references describe particles in terms of their mass, others in terms of size. For example, the unified atomic mass unit “u” (also called a Dalton, “Da”) is a unit used to express atomic and molecular masses. Units used to describe the size of small particles also include units of length—e.g., a micron, “μ” (also called a “micrometer”) is one millionth of a meter; a nanometer, “nm” is one billionth of a meter. When these units of length are used to describe particles, they make an approximation of the diameter of the particle as if each particle was a sphere, and as if all of the particles being characterized were of the same size. In fact, microscopic particles are of many shapes, and size characterizations are based on the mean size of particles that fall within a range.

Resistivity is one metric for characterizing the purity of water relative to dissolved ions. It is a measure of ability of the water to conduct electricity, which ability is a function of the amount of ionized substances (e.g., salts) dissolved in the water. (The fewer the dissolved salts, the higher the resistivity.) The theoretical maximum electrical resistivity for water is approximately 18.2 MΩ·cm at 25 degrees Celsius. Resistivity is a good general indicator of the effectiveness of deionization—i.e., ionic purity of the water—but does not measure water quality with respect to other important classes of contaminants, such as non-ionic contaminants, uncharged particles, etc.

Aqueous solutions of chlorine dioxide having enhanced stability are disclosed. The solutions are prepared with pure reagents, including both the water and the chlorine dioxide. These reagents are substantially free of undesirable, including ionic and non-ionic contaminants, that the inventors have discovered cause the breakdown of chlorine dioxide.

Manufacturing and packaging methods for aqueous solutions of chlorine dioxide are also contemplated herein. These methods are designed to prevent the introduction of multiple types of destabilizing contaminants. Ultimately, the product is substantially free of unwanted contaminants, including those that have not been considered in the existing chlorine dioxide patent art or scientific literature: transition metals, transition metal oxides, particles and organic carbon (TOC).

The use of reagents that are substantially free of undesirable contaminants, in concert with manufacturing and packaging methods that prevent the introduction of such unwanted contaminants, is preferred.

Aqueous solutions of chlorine dioxide can be prepared and certain undesirable contaminants (e.g., particles) removed by filtering or other processing steps, such that the resultant solutions are sufficiently pure (by multiple measures) to maintain stability of the concentration of chlorine dioxide better than solutions that have not been so prepared or treated.

The disclosed aqueous solutions of chlorine dioxide can maintain a stable concentration over many months or longer and minimize the deleterious effects of increased temperature and physical agitation, both in storage and in transport.

Typically, water contains a variety of chemical components; these components, even in very small amounts, can profoundly affect the chemistry of aqueous solutions of chlorine dioxide. Deionization processes may effectively remove dissolved charged particles (such as Mn²⁺), but will not remove to any significant extent other contaminants, such as agglomerated particles (Mn³⁺), uncharged molecules, undissolved particles and TOC.

Sources of TOC in water include natural organic matter (NOM) present in the raw feed-water, or can be contributed by “leachables”, e.g., from ion exchange resins. Most source water supplies used by municipal water treatment facilities do not contain high concentrations of man-made organics; NOM is generally composed of tannins, and of humic and fulvic material from decaying vegetation. The molecular weights of the molecules comprising NOM vary tremendously, with larger TOC constituents having molecular weights of up to 80,000. Municipal water treatment processes generally remove TOC constituents with molecular weights of more than 10,000. TOC is “finished” tap water is predominantly made up of chemicals with molecular weights of less than 10,000.

TOC levels of 2-5 ppm are typical of finished tap water in the United States. Tolerable TOC content in process water varies widely from industry to industry. For example, the pharmaceutical industry has adopted a standard of 0.500 ppm of TOC for “Water for Injection”, whereas the microelectronics industry has a minimum standard of no-more-than 0.010 ppm of TOC.

This invention recognizes, for the first time, that particles which are ubiquitous in the environment—including in the air and water and on surfaces—contribute to the deterioration of aqueous solutions of chlorine dioxide. Even uncharged particles that are otherwise substantially inert appear to facilitate the deterioration of the aqueous solutions of chlorine dioxide, especially on agitation such as encountered in trasport. Deionization does little to remove such particles.

Manganese is a naturally occurring substance found in many types of rock; it does not occur in the environment as the pure metal. Rather, it occurs in combination with other chemicals such as oxygen, sulfur, and chlorine. These compounds are solids that do not evaporate. However, small dust particles of the solid material can become suspended in air. Some manganese compounds can dissolve in water, and low levels of these compounds are normally present in lakes, streams, and the ocean. Manganese can change from one compound to another, but it does not break down or disappear in the environment.

Because manganese is a natural component in the environment, it is almost always present at low levels of it in water, air, soil and on surfaces. In tap water, levels are usually about 0.004 parts manganese per million parts of water (ppm). In air, levels are usually about 0.02 micrograms manganese per cubic meter of air (ug/m³). The US Occupational Safety and Health Administration (OSHA) permissible exposure limit (PEL) for airborne manganese is 5 mg/m³, but levels 10 times as high have regularly been detected in the environment.

Iron particles also are ubiquitous in the environment. Average environmental levels of airborne iron particles reported in the literature have ranged from 0.23 to 5.13 micrograms/m³.

A common form of water purification is deionization. Deionized water is water that has had dissolved mineral ions removed, such as cations from sodium, calcium, magnesium and anions such as chloride and bromide. Deionization is a physical process that uses ion exchange resins that bind to and filter out the dissolved mineral salts from water. However, deionization does not remove to any significant extent uncharged organic molecules, microorganisms, or particles except by incidental trapping in the resin.

Reagent water suitable for the present invention cannot generally be obtained from purification by application only of deionization. Similarly, water treated only by reverse osmosis (RO) or distillation is not of suitable quality for the present invention.

Water, such as municipal tap water, that has been treated subsequently by only one of these (i.e., deionization, distillation, RO) processes is unlikely to be of sufficient purity to yield an aqueous solution of chlorine dioxide which is stable (as to chlorine dioxide concentration) on storage and shipping, relative to the invention disclosed here. Rather, reagent water suitable for the present invention requires treatment by multiple processes, in order to remove the various types of unwanted contaminants.

Use of suitable reagent water, while necessary, is not sufficient to assure aqueous solutions of chlorine dioxide of adequate purity, because destructive contaminants can be introduced by other means—e.g., by contaminants in the chlorine dioxide that is dissolved into the reagent water. A multi-parameter purity can be achieved using (a) sufficiently-pure reagent water, (b) sufficiently-pure reagent chlorine dioxide, (c) substantially clean production means, and (d) substantially clean packaging.

A recent study used aqueous solutions of chlorine dioxide made from substantially chlorine free chlorine dioxide gas (by the Gas:Solid process), which was dissolved in deionized water and stored in white (TiO₂ pigment) high density polyethylene (“HDPE”) drums and in level-5 fluorinated HDPE drums. When the test solutions were prepared, no special steps were taken to filter the chlorine dioxide gas produced by said Gas:Solid process, nor to remove particles from the deionized water, nor to prevent the introduction of particles from environmental or other sources. The test solutions were stored at temperatures ranging from 18-29° C. The drums of test solution were left in place, undisturbed for the first approximately 9 months of the study. There was about 10% decrease in the chlorine dioxide concentration of the test solutions over the first approximately three months; the chlorine dioxide remained at a substantially stable concentration, showing no further detectable deterioration, for approximately six months. But, when the test drums were moved to another location, there was an additional 10% decrease in the chlorine dioxide concentration.

When shipped, similarly made aqueous solutions chlorine dioxide lost 10-15% or more of their chlorine dioxide concentration in a relatively short period, but the reported rates of deterioration were highly variable and inconsistent.

This invention recognizes for the first time the need, and provides methods and means for obtaining, substantially stable aqueous solutions of chlorine dioxide using reagent water prepared by multiple purification steps, in order to remove particles (e.g., colloidal silica, bacteria, viruses, pyrogens), organic carbon (TOC), and metal ions, especially transition metals and their oxides.

Both manganese and iron are found naturally in ground water. Aesthetic levels for iron in drinking water is less than or equal to 0.3 mg/L while the aesthetic level for manganese in drinking water is less than or equal to 0.05 mg/L.

Water can be purified by a number of means, including deionization, distillation and reverse osmosis (RO), but none of these alone will yield water with multi-parameter purity sufficient to the present invention. In addition to deionization, distillation and RO, other processes available to purify water include carbon filtration (adsorption), microfiltration, ultra-filtration, hyperfiltration, ultraviolet oxidation, or electro-dialysis. Each of these methods is capable of removing different types of contaminants. A combination of these processes, usually applied in series, can be used to produce water resulting in very-low levels of trace contaminants which are measured in parts per billion (ppb), or even parts per trillion (ppt). In general, the present disclosure includes, without limitation, the application of a combination of treatment processes, in order to produce reagent water that is characterized by very low quantities of multiple types of contaminants, including particles, organic carbon (TOC) and ionic species, especially transition metal ions and their oxides.

Surprisingly with regards to the present invention, water that contains certain contaminants in amounts that exceed the acceptable amounts under the general standards for deionized or distilled or RO-treated water, may be sufficient for the present purposes. For example, aqueous solutions of chlorine dioxide are relatively stable even with relatively large amounts of calcium and magnesium. However, we have found that manganese and iron are destructive at much lower levels.

Water quality standards for purified water have been established by a number of professional organizations, including the American Chemical Society (ACS), the American Society for Testing and Materials (ASTM), the National Committee for Clinical Laboratory Standards (NCCLS, now CLSI), and the U.S. Pharmacopeia (USP). ASTM, NCCLS, and ISO 3696 classify purified water into Grade 1-3 or Types I-IV depending upon the level of purity. These organizations have similar (though not identical) parameters for highly purified water. For the purposes of this invention description, ASTM classifications and nomenclature are used. However, comparable standards of the other organizations are included by reference.

Generally, water that meets ASTM types I, II and III are of sufficient quality on all parameters to meet the requirements of the present invention, ASTM Type I being the purest and most preferable.

Key ASTM parameters are:

| | | | |
|---|---|---|---|
| Ions | Resistivity at 25° C. | 18.2 − 0.25 | MΩ · cm |
| Organics | Total Organic Content (TOC) | 50 − 200 | ppb |
| Colloids | Silica (particles) | <3 − <500 | μg/mL |
| Chlorides | | 1 − 10 | μg/mL |
| Sodium | | 1 − 10 | μg/mL |

In addition to the use of sufficiently pure reagent water, care must also be taken to avoid introducing contaminants into the disclosed aqueous solutions of chlorine dioxide by other means. Potential sources of contaminants include, but are not limited to (a) microscopic particles in the dilute (1-15% concentration) chlorine dioxide gas that is mixed with or bubbled through or otherwise dissolved into the reagent water, (b) particles on the contact surfaces of production equipment and containers, and (c) additives (e.g., pigments) in the structure of the production equipment or reagent container (e.g., drum) material which can shed or leach into and react with the aqueous solution of chlorine dioxide. For example, blue pigment used in standard 55-gallon HDPE drums (Mauser) contains copper compounds that react with chlorine dioxide. When aqueous solutions of chlorine dioxide are stored in these drums, the blue color of the HDPE material is progressively removed, starting from the wetted surface contacting the solution, and at the same time the chlorine dioxide concentration deteriorates. None of these sources of potential contamination have previously been recognized.

The chlorine dioxide suitable for purposes of the present invention should be substantially free of chlorine gas, as is that produced by the Gas:Solid process described by Gordon and Rosenblatt in “Chlorine-free Chlorine Dioxide for Drinking Water Treatment” and also described by White and USEPA.

Whether using substantially pure chlorine dioxide generated in the gas phase (e.g., by the Gas:Solid method) or chlorine dioxide gas generated in and stripped from solution, there are many ways that the chlorine dioxide can and almost-inevitably will contain contaminants. Such contaminants include (a) soluble species (including manganese, chloride ion, chlorite ion, chlorate ion, perchlorate ion) and insoluble particles (silica) carried over in liquid aerosols, e.g., from gas stripping, and (b) microscopic particles of dust, e.g., from the solid sodium chlorite in the Gas:Solid reactors or from the (air or nitrogen) diluent used to carry the chlorine gas reactant and chlorine dioxide gas product of the Gas:Solid process. Air allowed into the chlorine dioxide production process from the manufacturing environment, as a diluent or otherwise, can also introduce particulates (e.g., manganese, iron, microorganisms, skin cells) that are generally present in the environment.

Chlorine dioxide suitable for purposes of the present invention also may be produced in solution using any of several wet-chemistry methods (such as those described by White and USEPA) so long as the chlorine dioxide gas reagent stripped from the solution is free of unwanted gas, liquid and solid contaminants prior to dissolution into the reagent water. One method is to generate the chlorine dioxide solution using relative amounts of reactants so as not to produce gas-phase contaminants (e.g., chlorine), strip the chlorine dioxide gas from the solution using air (or an inert gas, such as nitrogen), filter the stripped chlorine dioxide gas to remove particulates (including microscopic solids and aerosols), and dissolve the stripped gas into a suitable reagent water.

The reagents and solution product should be protected at every stage from the introduction of contaminants, including, without limitation, airborne particulates, volatile organic compounds, and extractables.

For example, the chlorine dioxide reagent gas should be filtered by a HEPA filter made of non-shedding chlorine dioxide-resistant material prior to its being mixed with the reagent water. A HEPA filter will filter out a minimum of 99.97% of all particles 0.3 microns or larger.

Preferably, the entire production process for the solution would be conducted under clean room conditions, in order to minimize the possibility of contamination of the solution by environmental contaminants, such as airborne particles.

The equipment used to dissolve the filtered chlorine dioxide gas reagent into the reagent water should be chemically compatible with chlorine dioxide, non-shedding and with minimum extractables. Acceptable materials include glass, or polymers such as virgin HDPE, PVDF, PTFE, CPVC and PVC. Process components should be substantially opaque to UV light, or else shielded from light.

Packaging should be made of materials that are chemically compatible with chlorine dioxide, such as virgin HDPE, PVDF, PTFE, CPVC and PVC and opaque to UV light. Colorants and other additives must be non-reactive with chlorine dioxide; an example of an acceptable additive used to make HDPE opaque is titanium dioxide (TiO₂).

All contact surfaces, including without limitation surfaces of production equipment, filling equipment and packaging, should be thoroughly cleaned of particles prior to use.

To the inventors' knowledge, this is the first disclosure in which the chlorine dioxide gas used to make aqueous solutions chlorine dioxide is treated—e.g., filtered—to remove particles, organic carbon (TOC), transition metal ions or oxides and other chemical moieties that may be carried over in aerosols or dust from the chlorine dioxide generation process or otherwise introduced during manufacturing, and packaging

1-48. (canceled)

49. A composition, comprising an aqueous solution of chlorine dioxide, wherein the solution is substantially free of transition metal ions, transition metal oxides, and particulate contaminants.

50. The composition of claim 49, wherein the solution has a chlorine dioxide concentration from about 100 ppm to about 10,000 ppm.

51. The composition of claim 49, wherein the solution has an organic carbon (TOC) content of less than 200 μg/L.

52. The composition of claim 49, wherein the solution has a total silica content of less than or equal to about 500 μg/mL.

53. The composition of claim 49, wherein the solution has a resistivity of approximately 0.25 MΩ·cm or greater at 25° C.

54. The compositions of claim 49, wherein the solution has total particulate contaminants of less than or equal to about 500 μg/mL.

55. The compositions of claim 49, wherein the solution has total chlorides of less than or equal to about 5 μg/mL.

56. The compositions of claim 49, wherein the solution has total sodium of less than or equal to about 10 μg/mL.

57. The composition of claim 49, wherein the solution is substantially free of ions.

58. The composition of claim 49, wherein the solution is substantially free of metal oxides.

59. A composition, comprising an aqueous solution of chlorine dioxide, wherein the solution has a chlorine dioxide concentration that remains substantially constant for at least three months during storage.

60. The composition of claim 59, wherein the solution is substantially free of transition metal ions, transition metal oxides, and particulate contaminants.

61. A method of preparing an aqueous solution of chlorine dioxide, comprising:
purifying water by at least two methods selected from the group consisting of deionization, distillation, reverse osmosis filtration, carbon filtration, microporous filtration, ultrafiltration, hyperfiltration, ultraviolet oxidation, and electrodialysis, and
dissolving a chlorine dioxide gas into the water.

62. The method of claim 61, wherein the chlorine dioxide gas is filtered to remove particles prior to being dissolved in water.

63. The method of claim 61, wherein the chlorine dioxide gas is treated to remove gas-phase contaminants prior to being dissolved in water.
